(19) United States
(12) Patent Application Publication
(10) Pub. No.: US 2005/0000918 A1
(43) Pub. Date: Jan. 6, 2005

(54) Suspension screen raking system

(76) Inventors: George Burgess, Auckland (NZ); Brian Burgess, Auckland (NZ)

Correspondence Address: YOUNG & THOMPSON, 745 SOUTH 23RD STREET, 2ND FLOOR, ARLINGTON, VA, 22202, US

(21) Appl. No.: 10/485,951

(22) PCT Filed: Aug. 7, 2002
(86) PCT No.: PCT/NZ02/00150

(30) Foreign Application Priority Data
Aug. 7, 2001 (NZ) 513378

(51) Int. Cl. B01D 29/64

(52) U.S. Cl. 210/791; 210/396

(57) ABSTRACT

A screen raking system having two or more rakes spaced along the length or height of the screen having longitudinal slots therein. The rakes are commonly displaceable along the length of the screen by a ram such as a single hydraulic, double acting, cylinder. The tines of each rake are displaceable between an extended position where they intedigertate with the bars of the screen, and a retracted position. The rakes are moved up and down the screen and the tines are extended and retracted so that solids deposited on the screen as a lower rake begins to descend are collected by a next-above rake as the latter begins to rise.

### FIELD OF THE INVENTION

This invention relates to a water screen raking system, by which is meant a system for the removal of solids and/or flotables (referred to generally herein as solids) from a screen placed across a channel or pool having a liquid suspension of such solids. Examples include a sewerage or other water treatment channel or a channel or reservoir supplying water to a turbine. Such screens, usually comprising spaced bars, are placed across such channels, typically at an angle to the vertical to act as a filter.

### BACKGROUND OF THE INVENTION

It is known to utilise a rake, the tines of which interdigitate with bars of a screen, to lift solids collecting on the bars to prevent the screen from becoming clogged. The rake lifts the solids to the top of the screen where they are tipped into a removal channel or bin or otherwise disposed of.

Such rakes are usually driven by a motor through a system of gears or chains and sprockets. This is not an ideal arrangement. It is complex and prone to jamming and failure. The use of an hydraulic or pneumatic ram would be preferable but because of the height of such screens it must have an unacceptably long stroke. It has therefore been proposed to use a telescopic ram but this also is a less than ideal arrangement because of its relative complexity and length.

### OBJECT OF THE INVENTION

It is an object of the present invention to provide a raking system or method which will at least go some way toward overcoming disadvantages of the prior art or which will at least provide the public with a useful choice.

### SUMMARY OF THE INVENTION

Accordingly in one aspect the invention may consist in a screen raking system including
a screen having longitudinal slots therein, a plurality of rakes spaced along the screen the rakes being displaceable along the screen by at least one driving means,
each rake having one or more tines and displacement means to displace the tines of between an inoperative position retracted relative to the screen as the rake moves towards a first end of the screen, and an operative position whereby the tines extend through the slots of the screen as the rake moves toward a second end of the screen,
the construction and arrangement being such that solids deposited on the screen by a first rake as the first rake begins to move toward the first end of the screen will be collected by a second rake as the second rake moves toward a second end of the screen.

Preferably the screen is arranged so that the longitudinal slots are substantially vertically orientated and the first end of the screen comprises a lower end of the screen, the second end or the screen comprises an upper end of the screen, the first rake is a lower rake and the second rake is an upper rake.

Alternatively the longitudinal slots are arranged substantially horizontally.

Preferably displacement means comprise a mechanical linkage acting between the rakes and the screen or apparatus dependent from the screen.

Preferably the rakes are mounted on a sub-assembly which is moveable relative to the screen.

Alternatively the displacement means comprise an actuator mounted between one or more of the rakes and the sub-assembly.

Preferably a plurality of sub-assemblies are provided, the sub-assemblies being linked together.

Preferably the sub-assemblies are capable of being displaced relative to the screen between two positions so that each rake may be moved between its two positions.

Preferably the displacement distance of each sub-assembly is the same as or slightly longer than mutual spacing between adjacent rakes.

Preferably the actuator comprises a hydraulic cylinder.

Preferably the ram means comprises a hydraulic cylinder.

Alternatively, the actuator and/or ram means comprises a rack and pinion arrangement, or a pneumatic ram.

Preferably the sub-assembly includes element support means to support the screen elements.

Preferably the element support means comprises a slotted lateral member.

Preferably the lateral member comprises a roller having a plurality of recessed slots therein, each slot being adapted to receive a rear edge of a screen element.

In another aspect the invention comprises a method of raking a water screen, the method including the steps of
(a) providing a screen having slots therein,
(b) providing a first rake and a second rake spaced along the screen, each rake being displaceable along the screen and having one or more tines capable of being displaced in an inoperative position in which the tines do not move solids collected on the screen along the screen, and in an operative position where the tines move solid material collected on the screen along the screen.
(c) displacing the tines in the operative position,
(d) moving the rakes toward a second end of the screen opposite to a first end of the screen,
(e) displacing the tines in the inoperative position,
(f) moving the rakes toward the first end of the screen until the second rake is located in a position adjacent to solids accumulated by the first rake in step (d), and repeating steps (c) and (d).

In a further aspect the invention provides a water screen raking system which includes
a plurality of rakes spaced along the height of a screen which comprises substantially upright horizontally spaced bars, all the rakes being commonly displaceable upwardly and downwardly with respect to the screen by at least one or more ram means,
each rake having one or more tines and a means being provided to displace the tines of each rake from an operative position extending between the bars of the screen as the rake moves upwardly to an inoperative position retracted relative to the screen as the rake moves downwardly.
the construction and arrangement being such that solids deposited on the screen as a lower rake begins to descend will be collected by the next-above rake as the latter begins to rise.

Preferably each rake is mounted on an actuating rod or arm which is turn journalled between a pair of bearings which run in channels or rails parallel with and on opposite sides of the screen.

Preferably carriages are provided to carry at least two consecutive rakes. Conveniently, the carriages can be mounted on or behind the screen.

The invention consists of the forgoing and also envisages constructions of which the following gives examples.

### BRIEF DESCRIPTION OF THE DRAWINGS

The invention is described, by way of non-limiting examples only, with reference to the accompanying drawings, in which:

FIGS. 1A to 1D are diagrammatic side elevations illustrating the raking cycle of the raking system of the present invention

FIG. 1E is a diagrammatic front elevation of the raking system shown in FIGS. 1A to 1D

FIG. 1F is a diagrammatic front elevation of the raking system of FIG. 1A to 1D, but with the screen disposed on a horizontal disposition rather than a vertical disposition whereby FIG. 1A to 1D comprise plan views

FIG. 2 is a partial side elevation of a first embodiment of a raking system according to the invention

FIG. 3 is a partial plan view of FIG. 2

FIG. 4 is an end view of the system of FIG. 2

FIG. 5 is a side elevation of a carriage comprising a sub-assembly of the apparatus of FIG. 2

FIG. 6 is a plan view of the carriage of FIG. 5

FIG. 7 is an end view of the carriage of FIG. 5

FIG. 8 is a partial side elevation of a second embodiment of the invention

FIG. 9 is a partial plan view of the system of FIG. 8

FIGS. 10A to 10D are end elevations of alternative forms of screen element for the screen of the raking system according to the invention.

### DESCRIPTION OF PREFERRED EMBODIMENTS

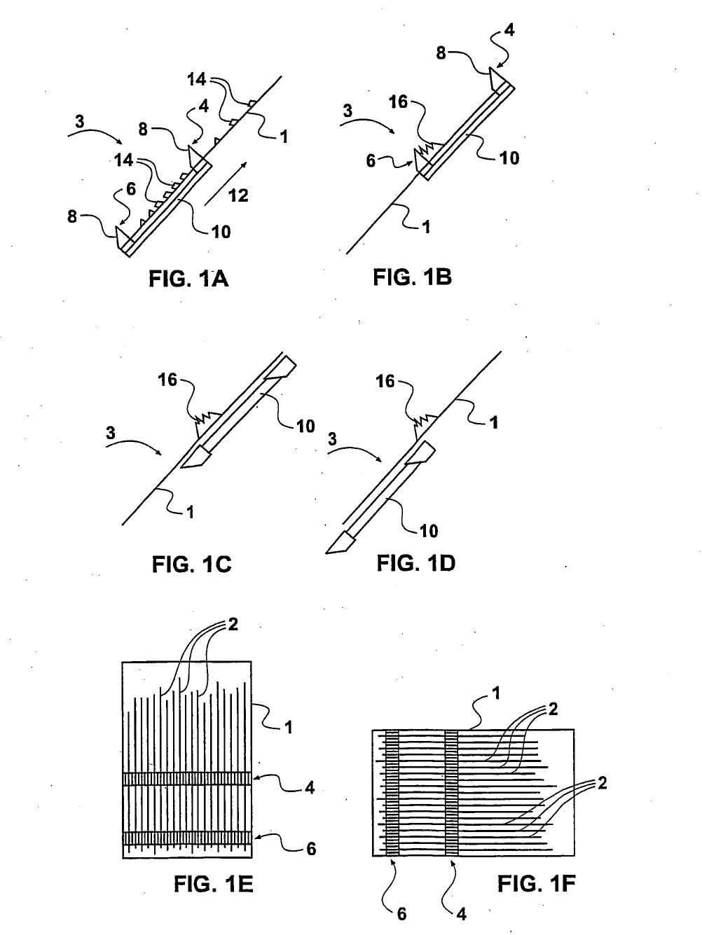

Operation of a screening system according to the invention is shown diagrammatically in FIGS. 1A to 1D. In those Figures, the screen 1 is shown in side elevation. However, it will be seen that the screen may also be viewed in FIGS. 1A to 1D as being plan views if the screen is arranged horizontally rather than vertically. This is more clearly shown in FIGS 1E and 1F. In FIG. 1E, a diagrammatic screen according to FIGS. 1A to 1D is shown in front elevation. As can be seen, this individual screen elements 2 are disposed vertically and spaced horizontally in FIG. 1E, but are disposed horizontally and spaced vertically in FIG. 1F. Thus the screening system according to the invention can be used with the screen elements arranged in a vertical or horizontal disposition, or possibly one or more intermediate dispositions. As can be seen from the diagrammatic illustrations in FIGS. 1E and 1F, the screen elements 2 have gaps in between adjacent elements. The gaps can be formed by the individual screen elements 2 simply comprising bars (the most preferred arrangement), or the screen could be manufactured in another manner, for example having slots cut out of a sheet material, or could alternatively be moulded or cast. In the most preferred embodiments the screen is constructed from steel, but those skilled in the art will appreciate that other materials could be used, for example suitable plastics materials. The screen operates by allowing liquid such as water to pass through the slots in between the screen elements, but impeding suspended solids. Therefore, the spacing between adjacent screen elements 2 is selected so as to provide an appropriate degree of filtering. Accordingly only suspended solids which have a dimension which is greater than the gap between adjacent screen elements will be trapped on the screen.

As is well known, it is highly desirable to remove solids that have collected on the screen (referred to generally in this document as “screenings”) in order to allow the screen to function properly. If the solids are not regularly removed from the screen, then the passage of liquid through the screen is impeded.

The screen face when disposed in a vertical position, is most preferably disposed at an angle of approximately 50-60 degrees from the vertical, sloping backwardly in the downstream direction relative to the flow of water through the screen. Typically, the screen is placed in a channel such as a water, sewerage or treatment channel. However, the screen may also be placed across an exit from a pool or other reservoir, such as the intake for a hydroelectric power station for example.

The rake assemblies for the present invention are provided at the rear of the screen, and the tines of each rake assembly may be arranged to project through the slots in the screen between the screen elements. However, a person skilled in the art to which the invention relates will realise that the rake assemblies for the present invention may be suspended above a front surface of thc screen and be extended to move the screening up the screen and also be retracted by moving rakes away front the front surface of the screen.

Referring again to FIG. 1A, two rakes generally referenced 4 and 6 are shown with rake tines or teeth 8 in the extended operable position with the tines projecting through slots in the screen 1. In this position, the tines 8 interdigitate with the screen elements. The rakes 4 and 6 are mounted on a sub-assembly or carriage 10.

The carriage 10 is capable of being moved relative to the screen in a direction substantially parallel to the screen. Therefore, if the carriage 10 is moved from the position shown in FIG. 1A up the screen in a direction shown by arrow 12 then the solids 14 will be collected by the tines 4 and 6. The result of movement in the direction shown by arrow 12 is illustrated in FIG. 1B, where the solids have been collected into a pile of screenings 16 by rake 6. The screenings that were collected by rake 4 have been moved by that rake off the top end of the screen. In practice, a bin (not shown) or similar disposal area is provided at or below the top end of the screen 1 so that screenings which have been collected by rake 4 may be disposed of.

The next step in the screening process is retraction of the tines 8 of rakes 4 and 6. This is shown in FIG. 1C. Referring to that Figure, it can be seen that the tines 8 have been moved to a retracted inoperable position where they are disposed in such a way that they do not interfere with the screenings 16 or any other solid matter (not shown) which may be deposited on the screen while the retraction operation occurs. FIG. 1C shows that the collected screenings 16 remain in position on the screen. This occurs because the angle of the screen is such that screenings do not tend to fall down the screen. Also, the flow of liquid through the screen, as represented by arrow 3, maintains a force against the screenings which maintains the screenings in place on the screen.

The next step, as shown in FIG. 1D, is to move the carriage 10 back to the position in which it was originally provided in FIG. 1A. However, in the movement of the carriage from its position shown in FIG. 1C to that shown in FIG. 1D, the tines 8 remain in the retracted position. The upper rake 4 has its tines position in such a manner that when the tines are moved to the extended position, the tines of the upper rake 4 will be located substantially behind the screenings 16. Therefore, the tines of the upper rake 4 will be located substantially in the same position as the tines of the lower rake 6 were in the position shown in FIG. 1B.

The next step is to extend the tines of the rakes so that they assume the orientation shown in FIG. 1A. In this orientation, the screenings 16 shown in FIG. 1D will be collected by the tines of the upper rake 4 ready for removal from the screen by being pushed off the screen by the upper rake 4 as described with reference to FIG. 1B.

It will be seen that the effect of the operation is to enable the rakes to be moved a distance which is considerably less than the length of the screen on which the rakes operate, while still allowing the rakes to effectively rake the entire length of the screen to remove screenings.

Although in the diagrammatic illustrations of FIG. 1A to 1F only two rakes are shown mounted on the carriage 10, many more rakes may be mounted on the carriage, depending upon the overall size of the screen and the distance over which the actuation device that moves the carriage is capable of extending. More rakes can be provided on a single carriage, or further carriages can be designed to be attached to an existing carriage with one or more rakes. Also, carriages can be provided across parts of the screen in a side by side relationship. Thus carriages may be operated in unison across a screen, or could be operated independently across a screen.

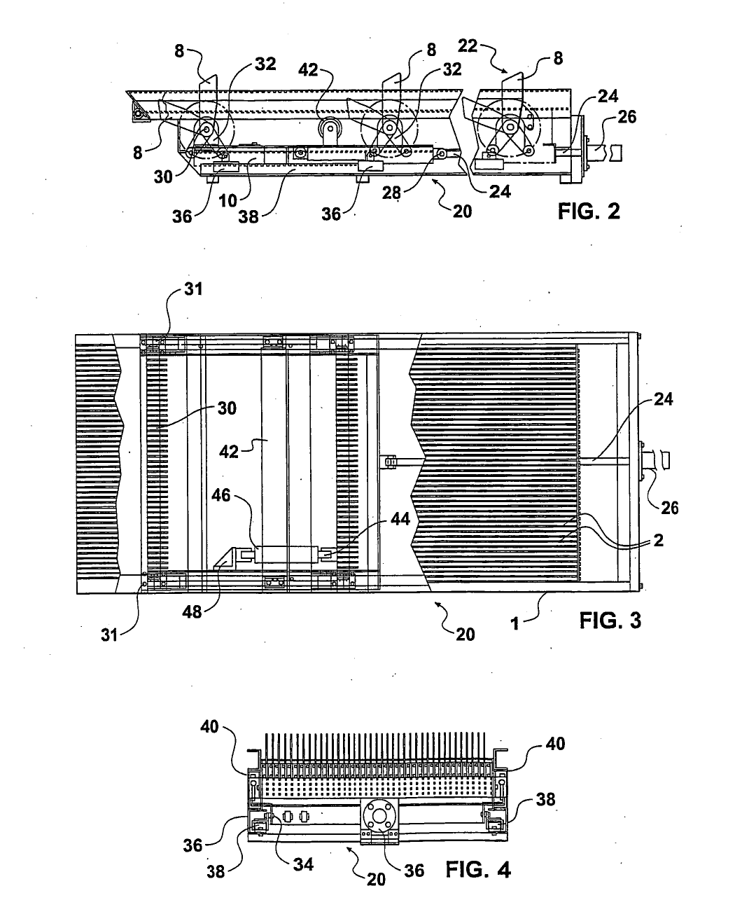

Turning now to FIGS. 2 to 4, one example of an embodiment of the invention is shown. In FIG. 2 a partial side elevation of a screening system is shown. The reference numerals used in FIG. 1A to 1F are used in the remaining drawings to illustrate features which are similar or the same.

The screening system of FIG. 2 is supported on a frame 20 to which the screening elements 2 are connected. There is a space between the rear part of the frame 20 and the screening elements. It is in this space that carriage 10 is provided. In a vertically disposed screen, the screening elements 2 are provided down the front face of the assembly and are mounted and fastened at the top and bottom of the frame. The screening elements are preferably post-tensioned. The carriage 10 shown in this embodiment has two rakes 4 and 6 mounted thereon. Another rake generally referenced 22 is illustrated, showing that the carriage may support more than two rakes. The carriage 10 is connected at one end to the output shaft 24 of a ram 26 such as a pneumatic or hydraulic ram. The shaft 24 is connected to carriage 10 by a pin 28. Although only a single ram 26 is shown, a dual hydraulic cylinder arrangement, or even further hydraulic cylinders may be provided depending upon the size of the installation. The most preferred form of actuation is hydraulic, but a pneumatic power source may also be used, as may a worm device or a rack and pinion arrangement. Hydraulic actuation has the advantages of simplicity, reliability and the ability to exert a considerable force which may be required in large installations. Each rake comprises a number of tines 8, and these are connected to a common shaft 30 which is journalled at either end in bearings 32.

Each rake shaft has an actuator 32 which is provided adjacent to one end of the shaft. The other end of the actuator is connected to a connecting member 34. A further shaft (not shown) connects members 34 of adjacent rakes together so that the tines of each rake move between operative and inoperative positions in unison. Although not clearly identified in the drawings, internal surfaces of the shoes 36 are coated with friction reducing materials, such as a suitable plastics material, in order to reduce friction between the shoes 36 and the rails 38.

The shoes 36 support the trolley relative to the frame, and the ends of the rake assemblies sit within hollow section members 40 of the frame.

A roller 42 is provided mounted on the carriage and contacts the rear edges of the screen elements 2. Therefore, the carriage 10 is mounted within the frame and screen by being supported at its lower edges on rails 38 and being guided and supported relative to the screen at its upper extremity by roller 42.

The actuating lever 32 of rake 4 is connected to an actuator arm 44 of a ram 46. The other end of the ram 46 is connected to the carriage by a connection bracket 48.

The ram 46 may be contracted to the orientation shown in FIG. 3 to extend the tines 8 so that the tines interdigitate with the screen and extend through the screen elements to be operable to move screenings along the screen. When the ram 46 is extended, the tines 8 are rotated about shaft 30 to be provided in their retracted position. The rake assembly is shown in this example as being rotated in order to extend or retract the tines, but the tines may alternatively be moved by a linear motion between these positions.

Cylinder 46 is actuated to move the tines, at the correct time in the raking operation cycle, to ensure solids are transferred in the correct direction along the screen. Also, ram 26 is actuated in a reciprocal fashion in order to move the carriage 10 between its two extreme positions on the screen. The spacing between rakes 4 and 6 is the same or less than the maximum stroke of the ram 26.

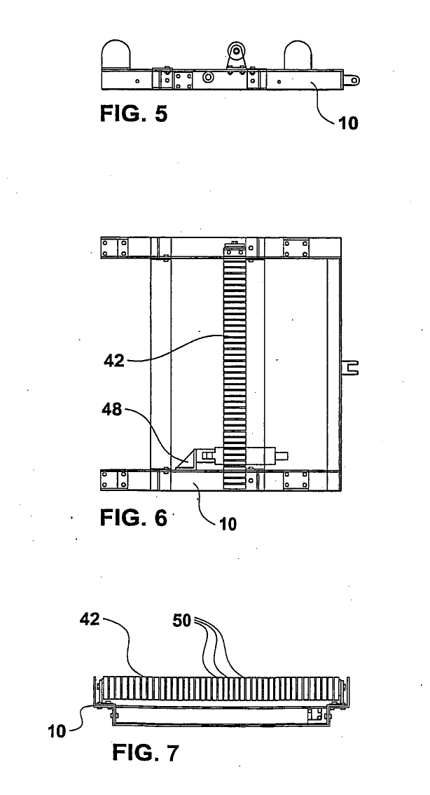

Turning to FIGS. 5 to 7, the carriage itself is shown in greater detail. In particular, the roller 42 can be seen to have a number of slots 50 of a reduced radius and these engage with the lower edges of the screen elements 2. Therefore, the roller assists in supporting the screen elements and in maintaining the correct spacing between the screen elements while the carriage is being transported between its extreme positions. An alternative to using the roller 42 is to use a beam which slides across the rear surfaces of the screen elements. Such a beam may be slotted, and have a friction reducing (e.g. plastics) coating.

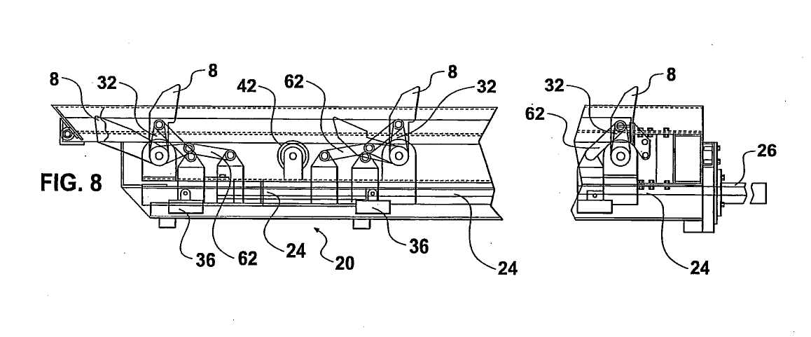

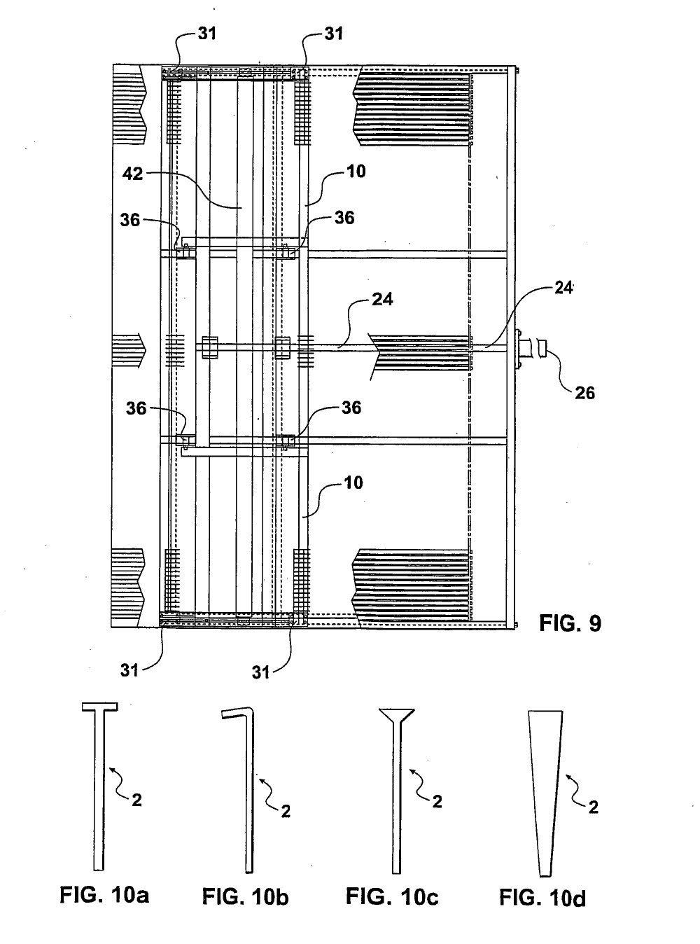

Referring now to FIGS. 8 and 9, another embodiment is illustrated. In this embodiment, the separate actuating cylinder 46 of the previous embodiment is not required.

Referring to FIG. 8, the driveshaft 24 of the main ram 26 runs through the carriage and is connected to a connector 60 for each rake assembly which in turn has an arm 62 that is pivotally connected thereto at one end. the other end of arm 62 being pivotally connected to actuation lever 32. In this embodiment, the actuation levers 32 are orientated at different angles relative to the tines. The arrangement, as can be seen from FIG. 8, is such that when members 60 are moved to the right as shown in FIG. 8, the tines are pulled into their extended operable positions. When members 60 are moved to the left as represented in FIG. 8, the tines are moved to their retracted, inoperable position. Since members 60 are in use connected to the main driveshaft 24, members 60 will be moved to the right so as to extend the tines when the carriage is moved to the right (relative to the screen as illustrated in FIG. 8). When the carriage is moved to the left relative to the screen, the tines will be retracted.

This movement is possible because of the friction between the carriage and the frame. Therefor, when the tines are in their retracted position and the carriage is at the base of the screens movement of the main driving arm 24 to the right, in order to drag the rakes up the screen will result firstly in the tines being moved to the extended position. Then, when the tines have reached their extended position, they can extend no further and continued movement of the arm 24 will then begin to move the carriage relative to the screen. Similarly, when the rakes have reached the top of the screen with the tines in the extended position then movement of the driving arm 24 in a direction towards the base of the screen will firstly move the tines to the retracted position. Then, when the tines have been fully retracted continued movement of shaft 24 will begin to move the carriage back down the screens (i.e. to the left of the drawing as illustrated in FIG. 8). Stops (not shown) are preferably included to limit the angular movement of the tines between the extended and retracted position so that the carriage as a whole will move when the full extent of extension or retraction of the tines has been achieved.

Turning now to FIG. 9, a plan view of the embodiment described in FIG. 8 is illustrated. As can be seen the four support rails have been provided so that the carriage extends across the full width of the screen. The driveshaft 24 is provided centrally, and the rakes are both operated by the driveshaft.

It is also apparent from FIG. 9 that a number of (for example three for the frame shown in FIG. 9) carriages may be provided side by side and linked together for example. Also, a number for example three carriages could be provided, each with its own driveshaft 24 and ram 26 to operate various sections of the screen independently.

Finally, turning to FIGS. 10A to 10D, various examples of screen elements 2 which may be used with the embodiments described above are illustrated. Screen elements can be provided in different forms, shapes and sizes depending upon the application for which they are required. In FIGS. 10A to 10D, the elements are provided as a web which has an end thereon that is exposed to the incoming waterflow. The web is typically 50-75 mm deep and lies substantially parallel to the liquid flow path. The width of the front face of the elements that is exposed to the flow path is approximately 10-30 mm depending upon the application. The most preferred screen element shape is that shown in FIG. 10B.

Screen elements may be made of various materials. The most desirable is stainless steel, but plastics materials, GRP, aluminium, or mild steel which has been suitable treated, for example by a galvanic process, may also be used. Throughout the description and claims of this specification the word “comprise”, and variations of That word, such as “comprises” and “comprising”, are not intended to exclude other additives, components integers or steps.

1. A screen raking system including a screen having longitudinal slots therein, a plurality of rakes spaced along the screen, the rakes being displaceable along the screen by at least one driving means, each rake having one or more tines and displacement means to displace the tines of between an inoperative position retracted relative to the screen as the rake moves towards a first end of the screen, and an operative position whereby the tines extend through the slots of the screen as the rake moves toward a second end of the screen, the construction and arrangement being such that solids deposited on the screen by a first rake as the first rake begins to move toward the first end of the screen will be collected by a second rake as the second rake moves toward a second end of the screen.

2. A screen raking system as claimed in claim 1 wherein the screen is arranged so that the longitudinal slots are substantially vertically orientated and the first end of the screen comprises a lower end of the screen, the second end of the screen comprises an upper end of the screen, the first rake is a lower rake and the second rake is an upper rake.

3. A screen raking system as claimed in claim 1 wherein the longitudinal slots are arranged substantially horizontally.

4. A screen raking system as claimed in claim 1 wherein displacement means comprise a mechanical linkage acting between the rakes and the screen or apparatus dependent from the screen.

5. A screen raking system as claimed in claim 1 wherein the rakes are mounted on a sub-assembly which is moveable relative to the screen.

6. A screen raking system as claimed in claim 5 wherein the displacement means comprise an actuator mounted between one or more of the rakes and the sub-assembly.

7. A screen raking system as claimed in claim 5 wherein a plurality of sub-assemblies are provided, the sub-assemblies being linked together.

8. A screen raking system as claimed in claim 7 wherein the sub-assemblies are capable of being displaced relative to the screen between two positions so that each rake may be moved between its two positions.

9. A screen raking system as claimed in claim 5 wherein the displacement distance of the sub-assembly by the driving means is the same as or slightly longer than mutual spacing between adjacent rakes.

10. A method of raking a water screen, the method including the steps of
(a) providing a screen having slots therein,
(b) providing a first rake and a second rake spaced along the screen, each rake being displaceable along the screen and having one or more tines capable of being displaced in an inoperative position in which the tines do not move solids collected on the screen along the screen, and in an operative position where the tines move solid material collected on the screen along the screen,
(c) displacing the tines in the operative position,
(d) moving the rakes toward a second end of the screen opposite to a first end of the screen,
(e) displacing the tines in the inoperative position,
(f) moving the rakes toward the first end of the screen until the second rake is located in a position adjacent to solids accumulated by the first rake in step (d), and repeating steps (c) and (d).

11. A water screen raking system including a plurality of rakes spaced along the height of a screen which comprises substantially upright, horizontally spaced bars, all of the rakes being commonly displaceable upwardly and downwardly with respect to the screen by at least one or more ram means, each rake having one or more tines and means being provided to displace the tines of each rake from an operative position extending between the bars of the screen as the rake moves upwardly to an inoperative position retracted relative to the screen as the rake moves downwardly, the construction and arrangement being such that solids deposited on the screen as a lower rake begins to descend will be collected by a next-above rake as the latter begins to rise.

12-14. (cancelled).
